(19) United States
(12) Patent Application Publication
(10) Pub. No.: US 2021/0013827 A1
(43) Pub. Date: Jan. 14, 2021

(54) Solar panel tent

(71) Applicant: Naimah Cunningham, Los Angeles, CA (US)

(72) Inventor: Naimah Cunningham, Los Angeles, CA (US)

(21) Appl. No.: 16/501,975

(22) Filed: Jul. 13, 2019

(51) Int. Cl. H02S 20/23; E04H 15/02

(52) U.S. Cl. CPC H02S 20/23; E04H 15/02

(57) ABSTRACT

The Solar Panel Tent is a tent that has a solar panel that can be attached or detached from the tents surface, allowing the solar panel to be conveniently placed in a location on the tents surface that provides the best access to the sun. The Solar Panel Tent allows you to charge a wide variety of devices while camping or during any outdoor activity.

### BACKGROUND OF THE INVENTION

### Field of the Invention

This invention relates to survival gear preparation, camping or any outdoor activity.

### Description of the Related Arts

There is no prior art that relates to this invention.

### BRIEF SUMMARY OF THE INVENTION

The Solar Panel Tent is a tent that has a solar panel that can be attached or detached from the tent's surface, allowing the solar panel to be conveniently placed in a location on the tent's surface that provides the best access to the sun.

### BRIEF DESCRIPTION OF THE DRAWINGS

FIG. 1 is a perspective view of the tent.

FIG. 2 is a blown-up view of the solar panel

FIG. 3 is a perspective view of the present invention illustrating the solar panel attached to various areas on the tents surface.

### DETAILED DESCRIPTION OF THE INVENTION

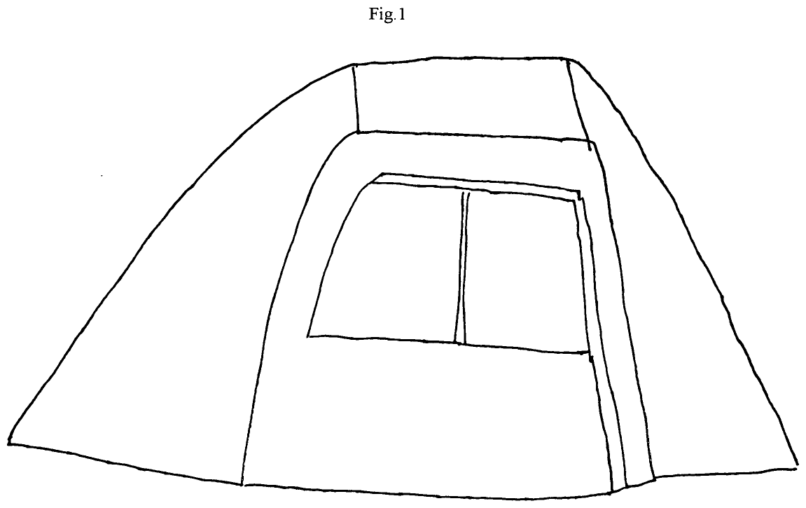

Overview: In FIG. 1, the tent.

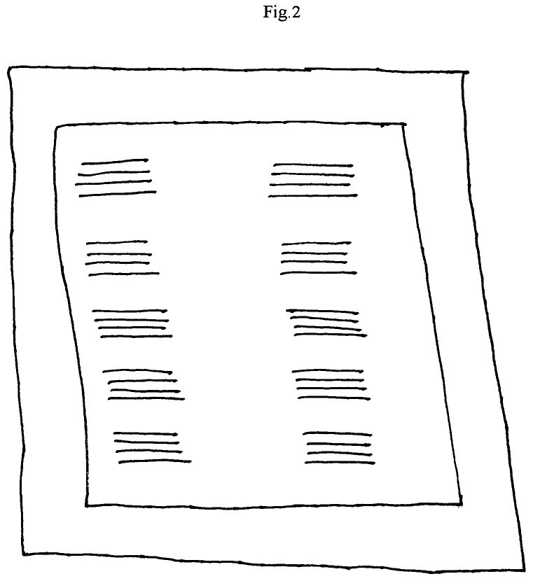

In FIG. 2, the solar panel.

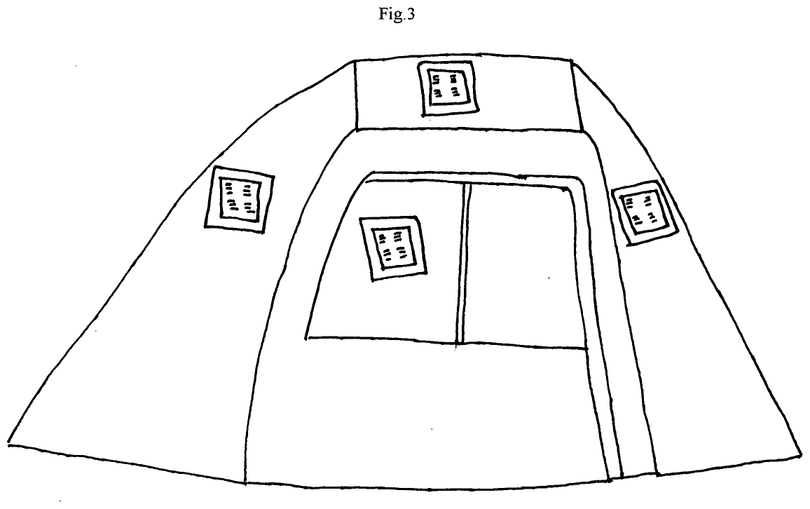

Solar Panel Tent: In FIG. 3, the tent with solar panel that can be attached or detached from the tents surface.

The claimed invention is:

1. A tent that include solar panel that can be attached or detached from the tent's surface.
